(19) United States
(12) Patent Application Publication
(10) Pub. No.: US 2025/0327673 A1
(43) Pub. Date: Oct. 23, 2025

(54) SEA ROUTE PLAN GENERATING SYSTEM AND POWER GENERATION FLOATING BODY

(71) Applicant: TOYOTA JIDOSHA KABUSHIKI KAISHA, Toyota-shi (JP)

(72) Inventors: Kazutaka KIMURA, Mishima-shi (JP); Hiroyuki NAKATANI, Gotemba-shi (JP); Masahiro TAKAHASHI, Nagakute-shi (JP)

(73) Assignee: TOYOTA JIDOSHA KABUSHIKI KAISHA, Toyota-shi (JP)

(21) Appl. No.: 19/038,008

(22) Filed: Jan. 27, 2025

(30) Foreign Application Priority Data
Apr. 19, 2024 (JP) 2024-068271

(51) Int. Cl. G01C 21/20; B63B 35/44; B63B 79/10; B63B 79/40; F03D 5/00; F03D 9/32

(52) U.S. Cl. CPC G01C 21/203; B63B 35/44; B63B 79/10; B63B 79/40; F03D 5/015; F03D 9/32; B63B 2035/446; F05B 2240/931; F05B 2240/95

(57) ABSTRACT

In the sea route plan generating system, a sea route plan generating unit that generates a sea route plan for sailing the power generation floating body that performs wind power generation using a kite while sailing at sea, at a predetermined sailing angle based on the wind conditions and a tidal current determining unit that determines whether or not there is an opposing tidal current opposed to the wind direction based on the wind conditions are provided for the power generation floating body that generates wind power using kite while sailing on the sea. When it is determined that there is an opposite tidal current, the sea route plan generating unit generates the sea route plan such that the power generation floating body proceeds at the sailing angle at which the power generation efficiency increases in the sea area of the opposite tidal current.

### CROSS-REFERENCE TO RELATED APPLICATION

This application claims priority to Japanese Patent Application No. 2024-068271 filed on Apr. 19, 2024, incorporated herein by reference in its entirety.

### BACKGROUND

### 1. Technical Field

The present disclosure relates to a technical field of a sea route plan generating system for generating a sea route plan for a ship, and of a power generation floating body including the sea route plan generating system.

### 2. Description of Related Art

As a system of this type, technology for calculating at least one of a traveling sea route and a travel destination for a ship based on wind direction and wind speed, tidal current, and so forth, has been proposed (see Japanese Unexamined Patent Application Publication No. 2022-164090 (JP 2022-164090 A)).

### SUMMARY

However, in JP 2022-164090 A, relations between wind conditions and tidal current are not taken into consideration in calculation of the traveling sea route and so forth. In particular, a power generation floating body that performs wind power generation using a kite at sea needs to use the natural environment, such as wind, in order to maximally increase power generation efficiency at sea.

An object of the present disclosure is to provide a sea route plan generating system and so forth, for generating a sea route plan such that power generation can be efficiently performed at sea by a power generation floating body, in which wind power generation using a kite is performed.

In order to solve the above problem, an aspect of a sea route plan generating system according to the present disclosure includes:
a sea route plan generating unit for generating, with respect to at least one power generation floating body that performs wind power generation using a kite while sailing at sea, a sea route plan for sailing the power generation floating body at a predetermined sailing angle based on wind conditions, and
a tidal current determining unit for determining whether a tidal current flowing in a direction opposite to a wind direction is present, based on the wind conditions, in which,
when determination is made that the tidal current is present, the sea route plan generating unit generates the sea route plan such that the power generation floating body proceeds at the sailing angle at which power generation efficiency of the wind power generation increases in a sea area of the tidal current.

In order to solve the above problem, an aspect of a power generation floating body according to the present disclosure is a power generation floating body that performs wind power generation using a kite while sailing at sea, the power generation floating body including
a sea route plan generating unit for generating a sea route plan for sailing the power generation floating body at a predetermined sailing angle based on wind conditions, and
a tidal current determining unit for determining whether a tidal current flowing in a direction opposite to a wind direction is present, based on the wind conditions, in which,
when determination is made that the tidal current is present, the sea route plan generating unit generates the sea route plan such that the power generation floating body proceeds at the sailing angle at which power generation efficiency of the wind power generation increases in a sea area of the tidal current.

According to the aspect of the sea route plan generating system of the present disclosure, wind power generation using the kite can be performed in the sea area where a tidal current flowing in a direction opposite to the wind direction is present. For example, in wind power generation by the kite, the amount of power generation increases as the amount of air that is received by the kite increases. Accordingly, generating power in a sea area in which a tidal current flowing opposite to the wind direction is present enables power generation efficiency to be enhanced as compared with when power is generated in a sea area with no tidal current. Further, according to the aspect of the power generation floating body of the present disclosure, the sea route plan generating system according to the present disclosure can be realized.

Such advantageous effects according to the present disclosure will become more apparent from the embodiments of the disclosure described below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an example of a configuration of a power generation floating body according to the present disclosure;

FIG. 2 is a flowchart illustrating an example of a power cycle sea route in which a power generation floating body according to the present disclosure navigates;

FIG. 3A is a schematic showing the relation between the opposite tidal current and the power cycle sea route;

FIG. 3B is a schematic showing the relation between parallel tidal currents and power cycle sea routes;

FIG. 4 is a flowchart illustrating an example of the sea route plan generation process according to the first embodiment;

FIG. 5 is a diagram illustrating an example of wind direction information;

FIG. 6 is a diagram illustrating an example of tidal current information;

FIG. 7 is a schematic diagram illustrating an example of a fleet formed of a plurality of power generation floating bodies;

FIG. 8 is an explanatory diagram illustrating a change in a sailing state with respect to a power generation floating body sailing at a constant sailing angle;

FIG. 9 is an explanatory diagram for explaining a change in sailing state with respect to a power generation floating body sailing in a constant GPS coordinate-direction; and

FIG. 10 is a flowchart illustrating an example of a sea route plan generation process according to the second embodiment.

### DETAILED DESCRIPTION OF EMBODIMENTS

### 1. First Embodiment

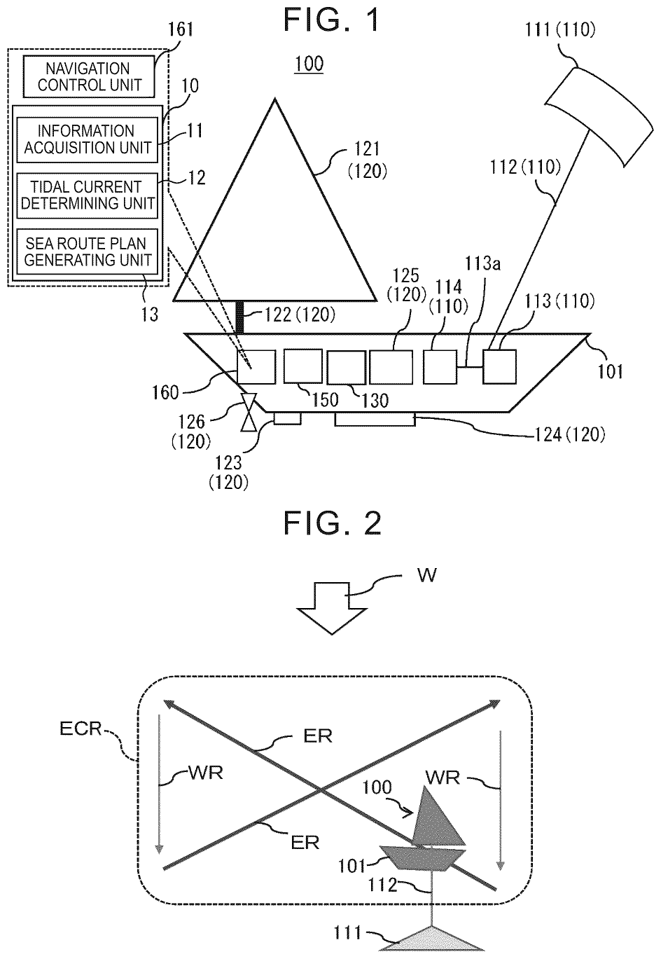

First, a power generation floating body 100 according to the present disclosure will be described with reference to FIG. 1. The power generation floating body 100 may be a sailing ship type floating body capable of navigating the sea. The power generation floating body 100 may be configured to be capable of navigating (i.e., sailing) the sea using wind energy received in the sail 121 as a power source. In the power generation floating body 100, wind power generation using the kite 111 connected to the hull 101 via the tether 112 may be performed. An example of the configuration of the power generation floating body 100 will be described in more detail. For example, as shown in FIG. 1, the power generation floating body 100 may include a power generation unit 110, a navigation unit 120, a storage unit 130, a floating body communication unit 150, and a floating body control unit 160.

The power generation unit 110 may include a plurality of elements utilized for wind power generation. The power generation unit 110 may include, for example, the tether 112 and the kite 111 described above, as well as the winch 113 and the generator 114. The winch 113 has a rotating shaft 113a as a rotating shaft, and the rotating shaft 113a is connected to a rotating shaft of the generator 114. A tether 112 is wound around the rotating shaft 113a. When the kite 111 is raised, the tether 112 is unwound from the winch 113 as the kite is raised. The rotating shaft 113a is rotated by the feeding-out operation of the tether 112. The rotation shaft of the generator 114 rotates in conjunction with the rotation when the kite 111 moves upward, so that electric power is generated. Further, when the rotating shaft 113a rotates in the winding direction of the tether 112, the tether 112 is collected and the kite 111 is lowered. When the tether 112 is collected, the generator 114 may rotate the rotating shaft 113a in response to a control instruction from the floating body control unit 160.

The navigation unit 120 may include a plurality of elements for causing the power generation floating body 100 to navigate at sea. In addition to the above-described sail 121, the navigation unit 120 may be provided with, for example, a mast 122 to which the sail 121 is attached, a rudder 123 for determining the direction of the hull 101, a center board 124 for generating a lateral force, and the like. The sail 121 may be configured to change the direction, tension (i.e., loosening) and the like with respect to the wind in response to a control instruction from the floating body control unit 160. The mast 122 may be, for example, a rotation mast that is rotatable with the sail 121 in response to a control instruction from the floating body control unit 160.

In addition to the movement by wind power, the power generation floating body 100 may include, for example, a thruster 126 and a motor 125 as a power source as the navigation unit 120 so as to be able to move by electric power. For example, electricity generated by the power generation unit 110 may be used to drive the motor 125. Further, the navigation unit 120 may include sensors necessary for navigation. The sensors may include, for example, a wind direction wind speed sensor, an acceleration sensor, an angular velocity sensor, a velocity sensor, and the like. For example, each element of the navigation unit 120 may be controlled by a control instruction from the floating body control unit 160 based on the sea route such that the power generation floating body 100 navigates a predetermined sea route.

The storage unit 130 may include a plurality of elements for storing electrical energy generated by the power generation unit 110. For example, the storage unit 130 may be configured such that electrical energy is stored as a hydrogen carrier. The storage unit 130 may comprise, for example, a hydrogen carrier generation unit (not shown). The hydrogen carrier generation unit may be configured to electrolyze water with the electrical energy generated by the power generation unit 110 to obtain a hydrogen carrier. Any hydrogen carrier may be employed, such as liquid hydrogen, ammonia, methylcyclohexane, and the like. The storage unit 130 may store the hydrogen carrier in a suitable storage manner depending on the hydrogen carrier employed. For example, when the hydrogen carrier is a hydrogen gas, the hydrogen gas may be stored in a hydrogen storage alloy tank.

The floating body communication unit 150 may be configured to enable wireless communication of information transmitted from other elements to the floating body control unit 160 and information (including control instructions) transmitted from the floating body control unit 160 to other elements. The “other element” may include, for example, equipment other than the power generation floating body 100, a system other than the sea route plan generating system, and the like. In addition, when two or more power generation floating bodies 100 are provided, “other elements” may include other power generation floating bodies 100. The floating body communication unit 150 may be configured to be capable of acquiring various types of positional information from a device (Global Navigation Satellite System (GNSS), a device (Global Positioning System (GPS), or the like in order to acquire the positional information of its own base.

The floating body control unit 160 controls various processes in the power generation floating body 100. The floating body control unit 160 may be configured as a control unit including, for example, a Central Processing Unit (CPU) and a storage device and an input/output interface required for the operation of CPU. The storage device may include, for example, Read Only Memory (ROM), Random Access Memory (RAM), and data storage. The floating body control unit 160 may be connected to each of the units 110, 120, 130, and 150 by a data bus, for example, via an input/output interface. The floating body control unit 160 may control various operations performed by the units 110, 120, 130, and 150. The storage device may hold various kinds of information necessary for each process performed by the power generation floating body 100. In the storage device, for example, a floating body ID may be held. The floating body ID may be unique information for identifying the power generation floating body 100. For example, various types of information (including a control instruction) output from the power generation floating body 100 may include a floating body ID to indicate an output source.

ROM may store, for example, a computer program for implementing a process in the floating body control unit 160. The floating body control unit 160 may read a computer program stored in a ROM or data storage. Alternatively, the floating body control unit 160 may acquire (i.e., download) a computer program from a device (not shown) disposed outside the power generation floating body 100 via the floating body communication unit 150, and read the acquired computer program. The floating body control unit 160 executes the read computer program. As a result, a logical functional block for controlling the operation of the power generation floating body 100 is realized in the floating body control unit 160.

As an example of the functional blocks realized in the floating body control unit 160, a navigation control unit 161, an information acquisition unit 11, a tidal current determining unit 12, and a sea route plan generating unit 13 are illustrated in FIG. 1. The navigation control unit 161 may, for example, control the navigation unit 120 to move the power generation floating body 100 in accordance with a predetermined sea route. For example, the navigation control unit 161 may control the sail 121, the rudder 123, and the like to sail the power generation floating body 100, and drive the motor 125 to move the power generation floating body 100 as necessary. The navigation control unit 161 may adjust, for example, the direction and tension of the sail 121 (so-called sail trim) according to the direction of the wind received by the power generation floating body 100. The navigation control unit 161 may control the rotation of the mast 122, for example, to adjust the orientation of the sail 121. Further, the navigation control unit 161 may also control the movement of the power generation floating body 100 by the motor 125.

The information acquisition unit 11, the tidal current determining unit 12, and the sea route plan generating unit 13 constitute the sea route plan generating system 10 according to the present disclosure. For example, the information acquisition unit 11 may acquire various types of information used in the sea route plan generating system 10 from an external information providing source via the floating body communication unit 150. For example, the tidal current determining unit 12 may determine a relationship between the direction of the wind and the direction of the tidal current. The sea route plan generating unit 13 may generate a sea route plan for increasing the power generation efficiency based on the wind conditions, for example.

Here, an example of the sea route plan generated by the sea route plan generating unit 13 will be described. FIG. 2 is an example of a sea route planned based on wind conditions in order to increase the power generation efficiency in the power generation floating body 100. As shown in FIG. 2, the route of the power generation floating body 100 may be set so as to repeatedly draw the power generation cycle sea route ECR in a predetermined sea area. The power generation cycle sea route ECR may alternately repeat the power generation sea route ER and the recovery sea route WR. The power generation sea route ER may be, for example, a sea route that causes the power generation floating body 100 to sail at an angle (e.g., in a closed-hold condition) toward the wind of the natural wind W as much as possible. The recovery sea route WR may be, for example, a sea route in which the natural wind W is used as a tailwind (for example, in a running condition), and the power generation floating body 100 is caused to sail. In the power generation sea route ER, power generation by the increase of the kite 111 may be performed. On the other hand, in the recovery sea route WR, the tether 112 may be recovered to lower the kite 111. In the power generation sea route ER, the power generation floating body 100 sails toward the wind at all times. Therefore, the amount of air received by the kite 111 increases, and the power generation efficiency can be increased.

As described above, the power generation cycle sea route ECR is set so as to increase the power generation efficiency based on the wind direction. The power generation floating body 100 may sail at a sailing angle corresponding to the respective sea route ER, WR with respect to the wind. The sailing angle may be an angle in the direction of travel with respect to the wind (i.e., “apparent wind”) experienced by the power generation floating body 100. The wind direction and the wind speed of the apparent wind may be detected by, for example, a wind direction/wind speed sensor provided in the power generation floating body 100. For example, the navigation control unit 161 may appropriately control the operations of the rudder 123, the mast 122, the sail 121, and the like so that the power generation floating body 100 sails at a sailing angle set according to the sea route. In addition, the navigation control unit 161 may perform a sail trim in accordance with an apparent wind so as to optimize the traveling direction.

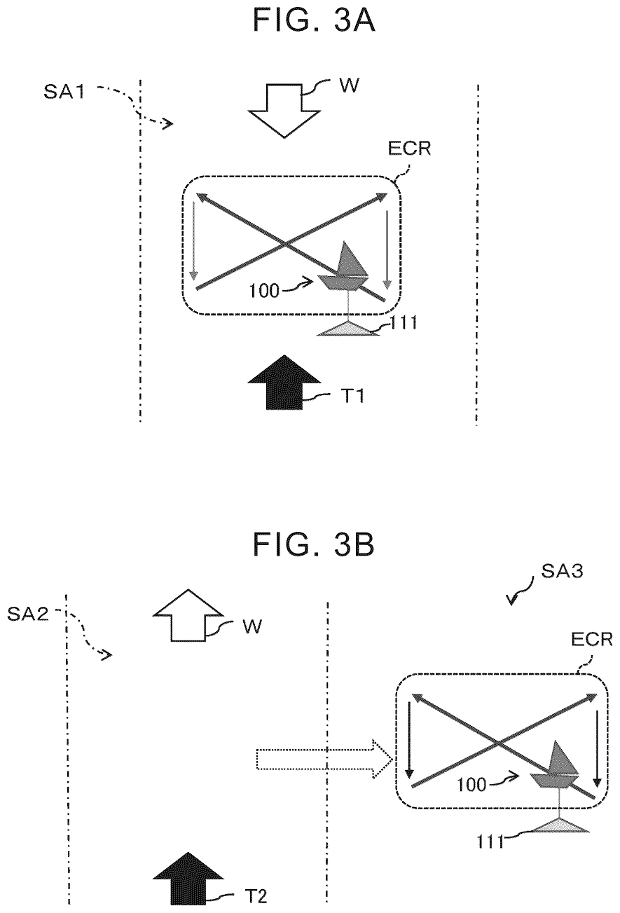

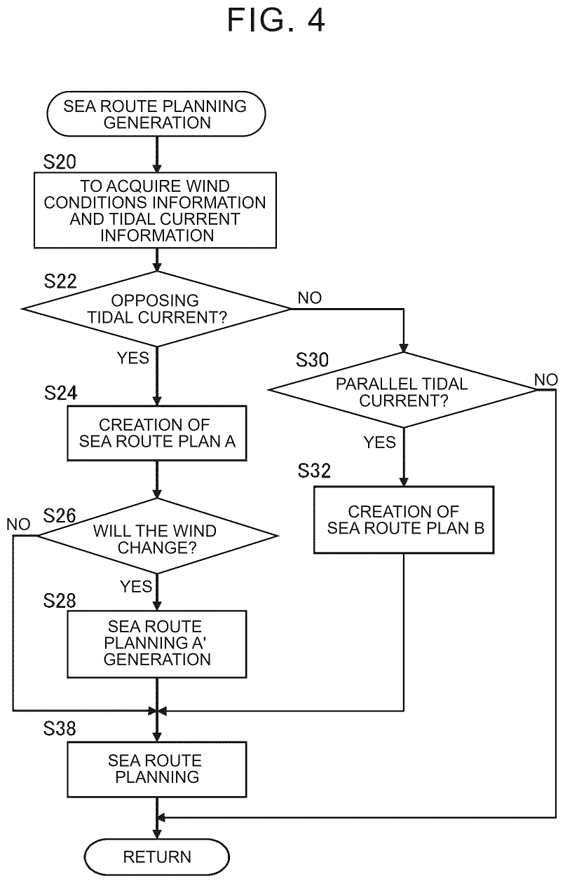

The sea route plan generating system 10 according to the present disclosure generates a sea route plan of a power generation floating body by utilizing not only wind conditions but also tidal currents in order to further enhance power generation efficiency. In the drawings used in the following description, a range surrounded by a dashed-dotted line indicates a sea area having a tidal current. For example, as shown in FIG. 3A, when the direction of the natural wind W and the direction of the tidal current T1 face each other, the sea route planning may be generated such that the power generation floating body 100 remains in the sea area SA1 corresponding to the tidal current T1 and repeatedly draws the power generation cycle sea route ECR. The area surrounded by the dashed-dotted line indicates the sea area where there is a tidal current. In this instance, the power generation floating body 100 is pushed to the windward side of the natural wind W by the tidal current T1. Therefore, the air volume of the air received by the kite 111 is larger than that in the case where there is no tidal current T1, and thus the power generation efficiency can be improved. Note that “facing” is not limited to cases where the direction of the tidal current T1 and the direction of the natural wind W completely face each other. The range of the direction of the tidal current T1 in which the air volume of the wind received by the kite 111 is larger than the predetermined reference value than when there is no tidal current T1 may be set to “face” the natural wind W. Hereinafter, the tidal current T1 opposed to the direction of the natural wind W is referred to as a counter-tidal current T1.

On the other hand, for example, as shown in FIG. 3B, when the direction of the natural wind W and the direction of the tidal current T2 are the same, the power generation floating body 100 is pushed to the leeward side of the natural wind W by the tidal current T2. Therefore, the air volume of the air received by the kite 111 is smaller than that in the case where there is no tidal current T2, and thus the power generation efficiency is low. Thus, for example, the sea route planning may be generated such that the power generation floating body 100 repeatedly depicts the power generation cycle sea route ECR outside the sea area SA2 corresponding to the tidal current T2 (e.g., in a sea area SA3 without tidal current). Note that the “same direction” is not limited to a case where the direction of the tidal current T2 and the direction of the natural wind W completely coincide with each other. The range of the direction of the tidal current T2 in which the air volume of the wind received by the kite 111 is smaller than the predetermined reference value than when there is no tidal current T2 may be set to “the same direction” as the natural wind W. Hereinafter, the tidal current T2 in the same direction as the direction of the natural wind W is referred to as a parallel tidal current T2.

An example of the sea route plan generation process performed by the sea route plan generating system 10 including the information acquisition unit 11, the tidal current determining unit 12, and the sea route plan generating unit 13 will be described with reference to FIG. 4. For example, when the power generation floating body 100 determines a sea area in which power generation is to be performed (that is, a sea area in which power generation cycle sea route ECR is to be performed), the sea route planning generation process may be performed. For example, the sea route plan generation process may be performed even when the power generation floating body 100 is navigating in accordance with an existing sea route plan.

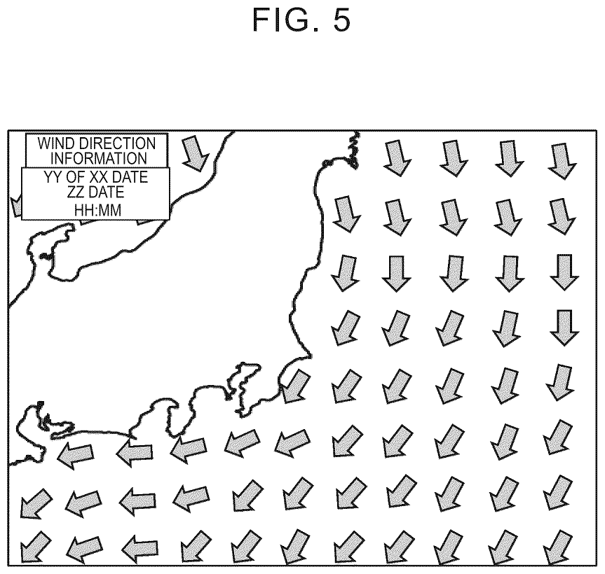

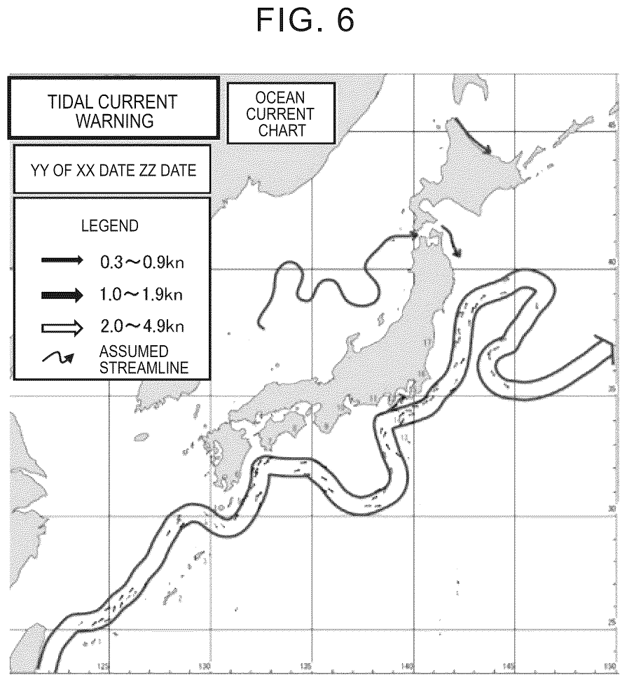

First, the information acquisition unit 11 of the sea route plan generating system 10 may acquire the wind direction information and the tidal current information (S20). The wind direction information may be, for example, information relating to the wind direction of a predetermined sea area including the own base, as illustrated in FIG. 5. The acquired wind direction information may include forecast information of the wind direction. The information acquisition unit 11 may acquire the wind direction information from a public institution providing the wind direction information via the floating body communication unit 150. For example, as illustrated in FIG. 6, the tidal current information may be information on a tidal current in a predetermined sea area including the own base. The tidal current information may include, for example, information on a shallow tidal current at a depth of the sea that affects the power generation floating body 100. The tidal current information may include, for example, the direction of the tidal current and the speed of the tidal current. The obtained tidal current information may include forecast information about the tidal current.

In the sea route plan generation process of FIG. 4, when the wind direction information and the tidal current information are acquired, the tidal current determining unit 12 of the sea route plan generating system 10 may determine whether or not there is an opposing tidal current T1 based on the wind direction information and the tidal current information (S22). When the determination is made based on the wind direction information in FIG. 5 and the tidal current information in FIG. 6 (Source: prepared by processing the “marine bulletin” (https://www1.kaiho.mlit.go.jp/KANKYO/KAIYO/qboc/) on the website of the Japan Coast Guard), it may be determined that there is an opposite tidal current T1 to the natural wind W in the sea area SA1 off the east coast of Chiba Prefecture. If an affirmative determination is made in S22 (S22: Yes), the sea route plan generating unit 13 of the sea route plan generating system 10 may generate the sea route plan A (S24), for example. sea route plan A may be planned such that, as shown in 3A, the power generation cycle sea route ECR is performed at a sea area SA1 corresponding to the opposite tidal current T1. For example, the sea route plan generating unit 13 may specify GPS information of the sea area SA1 (for example, the east coast of Chiba Prefecture) based on the wind direction information and GPS information obtained from the tidal current information (that is, the position information in GPS coordinates composed of longitude and latitude).

The sea route plan A may include, for example, the travel from the present position to the sea area SA1, and GPS data and the sailing angle for repeating the power generation cycle sea route ECR in the sea area SA1. If the power generation floating body 100 is in the sea area SA1, the sea route plan A may be generated such that, for example, the power generation floating body 100 remains in the sea area SA1 and repeats the power generation cycle sea route ECR. Subsequently, the sea route plan generating unit 13 may determine, for example, whether or not the wind direction of the sea area SA1 greatly changes within a predetermined period based on the forecast information regarding the wind direction (S26). For example, the sea route plan generating unit 13 may determine whether or not the wind direction of the sea area SA1 is in the same direction as the opposite tidal current T1. In S26, if a negative determination is made (S26: No), the sea route plan generating system 10 may set the sea route plan A to the sea route plan to be executed by the power generation floating body 100 (S38), for example. In this case, the navigation control unit 161 may control each element of the navigation unit 120 of the power generation floating body 100 based on the sea route plan A. After S38, the sea route plan generating system 10 may terminate the current sea route plan generating process.

If an affirmative determination is made in S26 (S26: Yes), the sea route plan generating unit 13 may generate the sea route plan A′ (S28), for example. The sea route plan A′ may be planned to move the power generation floating body 100 to a sea area without tidal current before the wind direction changes in the middle of the sea route plan A. When the sea route plan A′ is generated, for example, the sea route plan generating system 10 may set the sea route plan A′ to the sea route plan to be executed by the power generation floating body 100 (S38). In this case, the navigation control unit 161 may control each element of the navigation unit 120 of the power generation floating body 100 based on the navigation sea route plan A′. After S38, the sea route plan generating system 10 may terminate the current sea route plan generating process.

On the other hand, in S22, when a negative determination is made (S22: No), the tidal current determining unit 12 may determine whether or not there is a parallel tidal current T2 based on the wind direction information and the tidal current information (S30). In S30, if a negative determination is made (S30: No), the sea route plan generating system 10 may terminate the current sea route plan generation process. In this case, for example, the navigation control unit 161 may continue to execute the sea route plan currently being executed. If an affirmative determination is made in S30 (S30: Yes), the sea route plan generating unit 13 may generate the sea route plan B (S32), for example. sea route plan B may be planned such that, as shown in the FIG. 3B, the power generation cycle sea route ECR takes place in a sea area SA3 without tidal current.

For example, the sea route plan generating unit 13 may specify GPS information of the sea area SA3 based on the wind direction information and GPS information obtained from the tidal current information. In the sea route plan B, for example, GPS data, sailing angle, and the like may be planned for moving from the present position to the sea area SA3 and repeating the power generation cycle sea route ECR in the sea area SA3. When the sea route plan B is generated, the sea route plan generating system 10 may set the sea route plan B to the sea route plan to be executed by the power generation floating body 100 (S38), for example. In this case, the navigation control unit 161 may control each element of the navigation unit 120 of the power generation floating body 100 based on the navigation sea route plan B. After S38, the sea route plan generating system 10 may terminate the current sea route plan generating process.

The sea route plan generating system 10 is not limited to a mode provided in the power generation floating body 100. The sea route plan generating system 10 may be distributed between the power generation floating body 100 and other facilities, for example. The sea route plan generating system 10 may be implemented by, for example, cloud computing. When the plurality of power generation floating bodies 100 form a fleet and navigate, for example, the sea route plan generation process (FIG. 4) may be executed in each of the power generation floating bodies 100. In addition to the position information by GPS, or in place of the position information by GPS, the position information by GNNS may be adopted.

### 2. Second Embodiment

The method of determining the tidal current is not limited to the method based on the wind direction information and the tidal current information as in the first embodiment. In the second embodiment, the tidal current is determined by a method different from that in the first embodiment. Hereinafter, portions different from those of the first embodiment will be mainly described, and other portions will be omitted as appropriate. Configurations similar to those of the first embodiment will be described with the same reference numerals as those of the first embodiment.

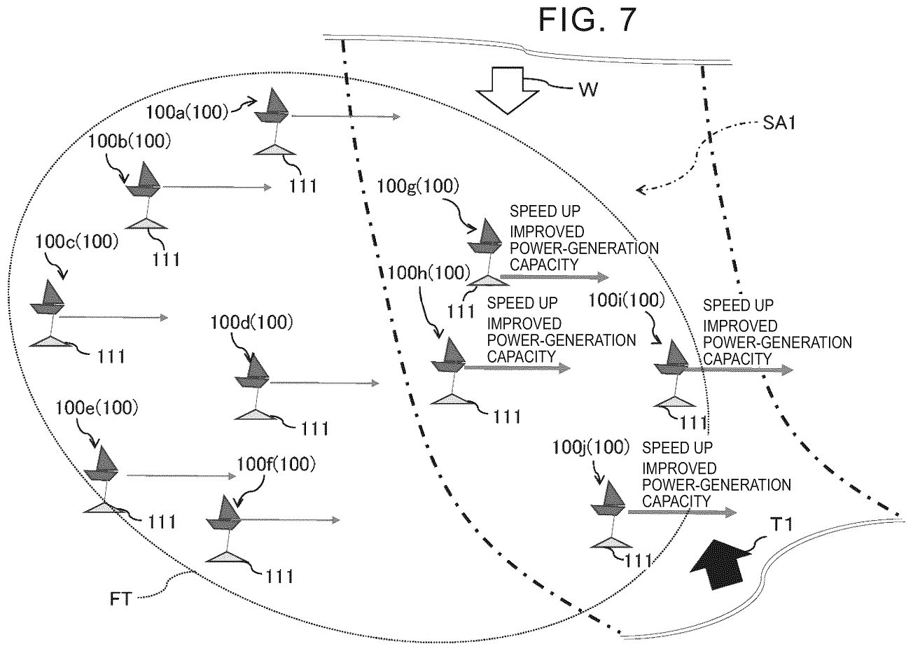

In the present embodiment, a case where a plurality of power generation floating bodies 100 are moving in a fleet will be described. For example, as shown in FIG. 7, ten power generation floating bodies 100a to 100j may form a fleet FT. The power generation floating body 100a to 100j may move in a fleet FT, for example, for a sea area in which the power generation cycle sea route ECR is to be executed. The number of power generation floating bodies 100 forming the fleet FT is not limited to 10, and may be an appropriate number according to demand. The configuration of the power generation floating body 100a to 100j may be the same as the configuration shown in FIG. 1. The respective power generation floating body 100a to 100j may be identified, for example, by a floating body ID. Hereinafter, the power generation floating body 100 is referred to as a “power generation floating body” when the respective power generation floating body 100a to 100j do not need to be distinguished.

The power generation floating bodies 100 may communicate with each other and transmit and receive information. For example, since the positions of the power generation floating bodies 100 are communicated with each other, the navigation control unit 161 of each power generation floating body 100 may cause the power generation floating body 100 to navigate while controlling the distance to the adjacent power generation floating body 100. In addition, the state information of each power generation floating body 100 may be shared between the power generation floating bodies 100. The state information may be, for example, at least one of information indicating a sailing state and information indicating a power generating state with respect to the power generation floating body 100. Details of the state information will be described later.

The navigation control unit 161 of the power generation floating body 100 may be configured to be able to measure not only the position of the own base in GPS coordinates (latitude and longitude) but also the information on the course in GPS coordinates (traveling direction and/or traveling angle) based on GPS information from GPS. Hereinafter, the information on the course in GPS coordinate will be referred to as “GPS course information”. In addition, a power generation amount sensor that monitors a power generation amount generated by the generator 114 of the power generation floating body 100 may be provided.

In the sea area where there is no tidal current, the sailing state and the power generating state of each power generation floating body 100 are the same. When the power generation floating body 100 enters the sea area where there is a tidal current, the sailing state and the power generating state of the power generation floating body 100 entering the sea area where there is a tidal current change. The sea route plan generating system 10 according to the present embodiment may determine the tidal current based on the difference in the sailing state or the power generating state between the power generation floating bodies 100. FIG. 7 shows a state in which the sailing state and the power generating state have changed with respect to the four power generation floating body 100g to 100j because the four power generation floating body 100g to 100j have entered the sea area SA corresponding to the opposite tidal current T1 SA1. In the sea area SA1, since the direction of the natural wind W and the direction of the opposite tidal current T1 face each other, the power generation floating body 100g to 100j is pushed in the wind upward direction of the natural wind W by the opposite tidal current T1, and the sailing state of the power generation floating body 100g to 100j changes. For example, the air volume of the wind received by the power generation floating body 100g to 100j increases, and the sailing speed of the power generation floating body 100g to 100j becomes higher than the sailing speed of the other power generation floating body 100a to 100f. Further, since the air volume of the air received by the kite 111 is also increased, the power generation amount per unit-hour of the power generation floating body 100g to 100j (hereinafter, simply referred to as “power generation amount”) is also larger than the power generation amount of the other power generation floating body 100a to 100f. In this manner, when the plurality of power generation floating bodies 100 are sailing in a fleet FT, the sea route plan generating system 10 may determine the tidal current by detecting a difference in the sailing state or the power generating state between the power generation floating bodies 100, for example.

A case will be described in which the sea route plan generating system 10 determines a tidal current by detecting a difference in the sailing state between the power generation floating bodies. In addition to the sailing velocity, the sailing angle and GPS coordinate-related information may be included in the sailing state in which the difference is detected. The sailing state may vary depending on the sailing method employed in the power generation floating body 100. As a sailing method of the power generation floating body 100, for example, a method 1 of sailing the power generation floating body 100 at a constant sailing angle or a method 2 of sailing in a constant GPS coordinate direction (that is, a traveling direction in GPS coordinates) may be employed.

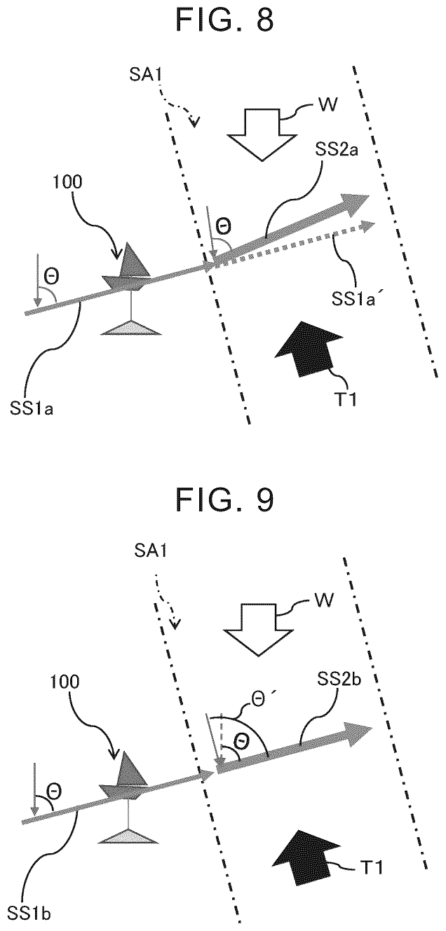

The change in the sailing state when the power generation floating body 100 adopting the method 1 enters the sea area SA1 of the opposite tidal current T1 will be described with reference to FIG. 8. When the power generation floating body 100 sailing at the constant sailing angle θ enters the sea area SA1, the apparent air volume increases as described above, and thus the sailing speed changes (increases). Further, by being pushed in the wind upward direction of the natural wind W by the opposite tidal current T1, the wind conditions (wind direction and wind speed) of the apparent wind received by the power generation floating body 100 is changed. In accordance with the wind conditions change of the apparent wind, the path (for example, the traveling direction) on GPS co-ordinate of the power generation floating body 100 sailing at the sailing angle θ changes.

In FIG. 8, the sailing state SS1a and the sailing state SS2a are shown as the sailing states of the power generation floating body 100 sailing at the sailing angle θ. The direction of the arrows SS1a, SS2a the sailing state indicates the traveling direction in GPS coordinates. The thicknesses of the arrows SS1a, SS2a the sailing states indicate the sailing speed, and the thicker the sailing speed indicates the higher. In the embodiment of FIG. 8, the power generation floating body 100 sails SS1a the sailing state and enters the sea area SA1, and sails SS2a the sailing state in which the sailing speed and the traveling direction are changed. Note that the sailing state SS1a″ (dotted arrow) in the sea area SA1 indicates the sailing state when the sailing state SS1a is continued.

In the method 1, sailing angles as well as sailing speed and GPS path information, for example, may be shared between the power generation floating bodies 100 as state information. The sea route plan generating system 10 may determine the tidal current by detecting a difference in sail speed and/or a difference in GPS route information.

The change in the sailing state when the power generation floating body 100 adopting the method 2 enters the sea area SA1 of the opposite tidal current T1 will be described with reference to FIG. 9. In the sea area where there is no tidal current, the power generation floating body 100 adopting the method 2 may sail at a sailing angle θ corresponding to the traveling direction in GPS coordinate. When the electric power generation floating body 100 sailing in a certain traveling direction enters the sea area SA1 having the opposite tidal current T1, as described above, the air volume of the apparent wind increases, and therefore the sailing speed changes (increases). Further, by being pushed in the wind upward direction of the natural wind W by the opposite tidal current T1, the wind conditions (wind speed and wind direction) of the apparent wind received by the power generation floating body 100 is changed. As the wind conditions of the apparent wind changes, the sailing angle θ changes to the sailing angle θ′ in order to maintain the traveling direction of the power generation floating body 100.

In FIG. 9, the sailing state SS1b and the sailing state SS2b are illustrated as the sailing state of the power generation floating body 100 traveling in a constant traveling direction. The direction of the arrows SS1b, SS2b the sailing state indicates the traveling direction in GPS coordinates. The thicknesses of the arrows SS1b, SS2b the sailing states indicate the sailing speed, and the thicker the sailing speed indicates the higher. In the embodiment of FIG. 9, when the power generation floating body 100 sails SS1b the sailing state and enters the sea area SA1, it sails SS2b the sailing state in which the sailing speed and the sailing angle are changed.

In the method 2, in addition to GPS route information, for example, wind conditions information (information on wind direction and wind speed) of the sail speed and the apparent wind may be shared as the state information. The sea route plan generating system 10 may determine the tidal current by detecting a difference in sail speed and/or a difference in wind conditions information of an apparent wind. Note that the wind conditions information of the apparent wind may be, for example, information obtained based on a sail trim in which the sail 121 is adjusted according to the wind conditions.

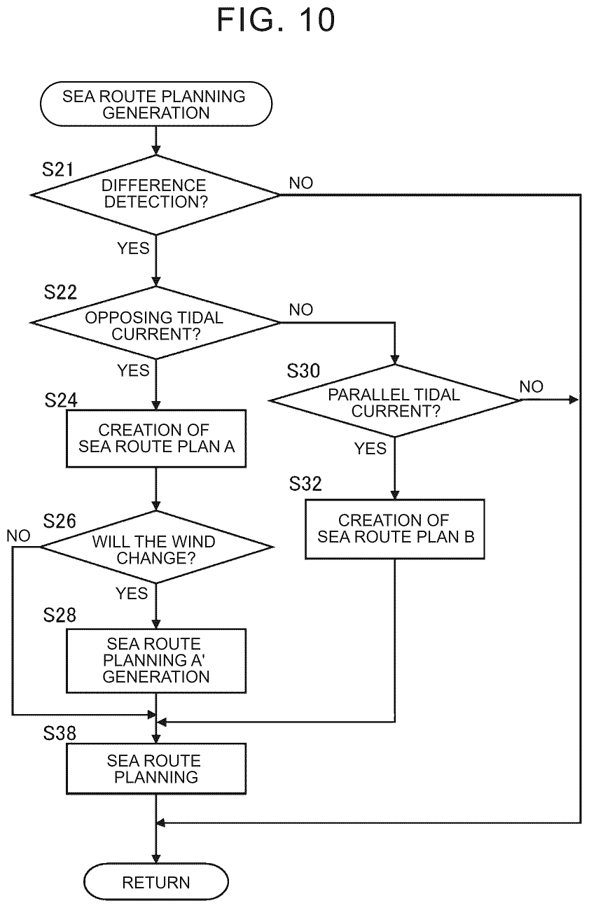

An example of the sea route plan generation process according to the second embodiment will be described with reference to FIG. 10. The sea route plan generation process may be executed by the sea route plan generating system 10 of each of the power generation floating bodies 100. For example, the sea route plan generation process may be performed while each power generation floating body 100 is sailing based on an existing sea route plan. For example, the sea route plan generation process may be performed while each power generation floating body 100 is sailing in a sea area without a tidal current.

First, the tidal current determining unit 12 of the sea route plan generating system 10 may determine whether or not there is a difference in state (here, a difference in sailing state) between the power generation floating bodies 100 in the fleet FT (S21). When the method 1 is adopted as the sailing method, when a difference is detected with respect to the sailing speed and/or GPS course information, the tidal current determining unit 12 may determine that there is a difference in the sailing state. When the method 2 is employed in the sailing method, when a difference is detected with respect to the sailing speed and/or the apparent wind conditions information, the tidal current determining unit 12 may determine that there is a difference in the sailing state. The detected difference may be a difference equal to or larger than a predetermined lower limit. In addition, the tidal current determining unit 12 may determine that there is a difference, for example, when the number of the power generation floating bodies 100 whose sailing state has changed is two or more (for example, a predetermined number or more). As a result, the accuracy of the determination in S21 can be increased.

In S21, if a negative determination is made (S21: No), the sea route plan generating system 10 may terminate the current sea route plan generation process. In this case, for example, the navigation control unit 161 may continue to execute the currently executed sea route plan. If an affirmative determination is made in S21 (S21: Yes), the tidal current determining unit 12 may determine whether the difference in the sailing state is due to the opposite tidal current T1 (S22), for example. For example, when the change in the sailing velocity is a change that increases, the tidal current determining unit 12 may determine that the difference in the sailing state is due to the opposite tidal current T1. If an affirmative determination is made in S22 (S22: Yes), the sea route plan generating unit 13 of the sea route plan generating system 10 may generate the sea route plan A (S24), for example.

Traffic sea route plan A may include, for example, a travel from the present location to the sea area SA1 and a trafficking sea route plan for repeating the power generation cycle sea route ECR in the sea area SA1. For the power generation floating body 100 in the sea area SA1, for example, the sea route plan A may be generated such that the power generation floating body 100 remains in the sea area SA1 and repeats the power generation cycle sea route ECR. In the sea route plan A, GPS route information, the sailing angle, and the like may be set according to the sailing method and the route adopted. For example, the sea route plan generating unit 13 may specify the position of the sea area SA1 (for example, the position in GPS coordinate) based on the position of the power generation floating body 100 whose sailing state has changed.

Subsequently, the sea route plan generating unit 13 may determine, for example, whether or not the wind direction of the sea area SA1 greatly changes within a predetermined period based on the forecast information regarding the wind direction (S26). For example, the sea route plan generating unit 13 may determine whether or not the wind direction of the sea area SA1 is in the same direction as the opposite tidal current T1. The forecast information regarding the wind direction may be acquired by the information acquisition unit 11 from an external information providing source, for example. In S26, if a negative determination is made (S26: No), the sea route plan generating system 10 may set the sea route plan A to the sea route plan to be executed by the power generation floating body 100 (S38), for example. In this case, the navigation control unit 161 may control each element of the navigation unit 120 of the power generation floating body 100 based on the sea route plan A. After S38, the sea route plan generating system 10 may terminate the current sea route plan generating process.

If an affirmative determination is made in S26 (S26: Yes), the sea route plan generating unit 13 may generate the sea route plan A′ (S28), for example. The sea route plan A′ may be planned to move the power generation floating body 100 to a sea area without tidal current before the wind direction changes in the middle of the sea route plan A. When the sea route plan A′ is generated, for example, the sea route plan generating system 10 may set the sea route plan A′ to the sea route plan to be executed by the power generation floating body 100 (S38). In this case, the navigation control unit 161 may control each element of the navigation unit 120 of the power generation floating body 100 based on the navigation sea route plan A′. After S38, the sea route plan generating system 10 may terminate the current sea route plan generating process.

On the other hand, when a negative determination is made in S22 (S22: No), the tidal current determining unit 12 may determine whether or not the difference in the sailing state is due to the parallel tidal current T2 (FIG. 3B), for example (S30). For example, when the change in the sailing velocity is a change that decreases, the tidal current determining unit 12 may determine that the difference in the sailing state is due to the parallel tidal current T2. In S30, if a negative determination is made (S30: No), the sea route plan generating system 10 may terminate the current sea route plan generation process, for example. In this case, for example, the navigation control unit 161 may continue to execute the currently executed sea route plan.

If an affirmative determination is made in S30 (S30: Yes), the sea route plan generating unit 13 may generate the sea route plan B (S32), for example. The sea route plan B may be planned, for example, such that a parallel tidal current T2 is avoided. In the sea route plan B, for example, a route for moving the power generation floating body 100 in the direction of a sea area where there is no tidal current may be planned. In the sea route plan B, GPS route data, the sailing angle, and the like may be set according to the sailing method employed. For example, based on the position of the power generation floating body 100 in which the sailing state has changed, the sea route plan generating unit 13 may specify the position of the sea area SA2 (for example, the position in GPS coordinate) and determine the direction in which the sea area SA2 is avoided. When the sea route plan B is generated, the sea route plan generating system 10 may set the sea route plan B to the sea route plan to be executed by the power generation floating body 100 (S38), for example. In this case, the navigation control unit 161 may control each element of the navigation unit 120 of the power generation floating body 100 based on the navigation sea route plan B. After S38, the sea route plan generating system 10 may terminate the current sea route plan generating process.

As described above, in the sea area where the opposite tidal current T1 (FIG. 7) is present, the power generation quantity of the power generation floating body 100 increases. On the other hand, in the sea area where the parallel tidal current T2 (FIG. 3B) is present, the amount of air received by the kite 111 is reduced, and thus the amount of power generated by the power generation floating body 100 is reduced. As described above, the state of the power generation amount of the power generation floating body 100 changes due to the tidal current. The sea route plan generating system 10 may determine the tidal current by detecting a difference in the power generating state between the power generation floating bodies 100. The power generating state in which the difference is detected may include, for example, the amount of power generated by the generator 114 of each of the power generation floating bodies 100. In this case, the state information shared between the power generation floating bodies 100 may include information on the amount of power generation.

A sea route plan generation process performed with respect to a difference in power generating state is described. In S21, the tidal current determining unit 12 of the sea route plan generating system 10 may determine whether or not there is a difference in state (here, a difference in power generating state) between the power generation floating bodies 100 based on the shared state information. For example, when a difference is detected with respect to the power generation amount, the tidal current determining unit 12 may determine that there is a difference in the power generating state. In S22, for example, when the change in the power generation rate is a change that increases, the tidal current determining unit 12 may determine that the difference in the power generating state is due to the opposite tidal current T1. If a negative determination is made in S22 (S22: No), the tidal current determining unit 12 may determine whether or not the difference in the power generating state is due to the parallel tidal current T2 (FIG. 3B), for example (S30). For example, when the change in the power generation rate is a change that decreases, the tidal current determining unit 12 may determine that the difference in the power generating state is due to the parallel tidal current T2. The other processing may be the same as the processing described above.

The sea route plan generating system 10 may determine the tidal current when a difference is detected, for example, in terms of both the sailing state and the power generating state. In this case, the shared state information may include a sailing state and a power generating state. In the sea route planning generation process (FIG. 10), in S22, the tidal current determining unit 12 may determine that the difference in the power generating state is due to the opposite tidal current T1, for example, when both the change in the sailing velocity and the change in the power generation rate are large changes. In addition, in S30, the tidal current determining unit 12 may determine that the difference in the power generating state is due to the parallel tidal current T2, for example, when both of the change in the sailing velocity and the change in the power generation rate become small.

Among the plurality of power generation floating bodies 100 forming the fleet FT, one power generation floating body 100 may function as a parent base. The sea route plan generating system 10 may be provided in the floating body control unit 160 of the parent base. Here, the state information and the position information of the respective power generation floating bodies 100 in the fleet FT may be collected on the parent basis. In addition, in the parent group, the route progress generation process may be executed, and a sea route plan may be generated and provided for each power generation floating body 100.

### ADDITIONAL REMARKS

With regard to the embodiments described above, the following additional notes are further disclosed.

### Appendix 1

The sea route plan generating system according to Appendix 1 is provided with a sea route plan generating unit that generates a sea route plan for sailing the power generation floating body that performs power generating using a kite while sailing at sea, at a predetermined sailing angle based on a wind conditions, and a tidal current determining unit that determines whether or not there is a tidal current in a direction opposite to the wind direction based on the wind conditions, and the sea route plan generating unit generates the sea route plan such that, when it is determined that there is the tidal current, the power generation floating body proceeds at the sailing angle at which the power generation efficiency of the wind power generation increases in the sea area of the tidal current.

According to the sea route plan generating system described in Appendix 1, it is possible to perform wind power generation using a kite in a sea area where there is a tidal current in a direction opposite to the wind direction. For example, in wind power generation by a kite, the amount of power generation increases as the amount of air received by the kite increases. For example, in a case where the power generation floating body is caused to sail toward the wind at the time of power generation, if power generation is performed in a sea area having a tidal current that opposes the wind direction, power generation efficiency can be enhanced as compared with a case where power generation is performed in a sea area without a tidal current.

### Appendix 2

The sea route plan generating system according to Appendix 2 is the sea route plan generating system according to Appendix 1, wherein the sailing angle at which the power generation efficiency increases is a sailing angle at which an apparent wind received by the kite increases.

According to the sea route plan generating system described in Appendix 2, since the air volume received by the kite increases and the lift of the kite increases in proportion to the air volume, the power generation efficiency can be increased. Therefore, as the sailing angle at which the power generation efficiency increases, for example, a sailing angle at which the power generation floating body sails toward the wind as much as possible so that the amount of air received by the kite increases can be considered.

### Appendix 3

The sea route plan generating system according to Appendix 3 is the sea route plan generating system according to Appendix 1 or 2, further comprising an information acquisition unit that acquires information from the outside, wherein the tidal current determining unit determines whether or not there is the tidal flow based on the tidal current conditions information regarding the tidal flow acquired by the information acquisition unit and the wind conditions information regarding the wind conditions acquired by the information acquisition unit, and wherein the sea route plan generating unit generates the sea route plan based on the wind conditions information.

According to the sea route plan generating system described in Appendix 3, information provided externally (that is, wind conditions information and tidal current information) can be used for determination by the tidal current determining unit.

### Appendix 4

The sea route plan generating system according to Appendix 4, wherein the plurality of power generation floating bodies form a fleet while communicating between the power generation floating bodies, and state information including at least one of a sailing state and a power generating state of each of the power generation floating bodies is shared between the plurality of power generation floating bodies, and the tidal current determining unit determines whether or not there is the tidal current based on a change in state information of each of the power generation floating bodies, and the sea route plan generating unit generates the sea route plan such that a sea area of the tidal current is included when it is determined that there is the tidal current. The sea route plan generating system according to claim 1 or 2.

According to the sea route plan generating system described in Appendix 4, it is determined whether or not there is a tidal current (that is, a counter tidal current) in a direction opposite to the wind direction based on a change in state information of each power generation floating body forming the fleet. Since sailing and power generation in the power generation floating body are performed using wind power at sea, the sailing state and the power generating state of the power generation floating body change depending on the wind conditions and the direction of the tidal current. In the sea route plan generating system described in Appendix 4, the change is used to determine whether or not there is an opposite tidal current.

### Appendix 5

The power generation floating body described in Appendix 5 is provided with a sea route plan generating unit that generates a sea route plan for sailing the power generation floating body that performs power generating using a kite while sailing at sea, at a predetermined sailing angle based on a wind conditions, and a tidal current determining unit that determines whether or not there is a tidal current in a direction opposite to the wind direction based on the wind conditions, and the sea route plan generating unit generates the sea route plan such that, when it is determined that there is the tidal current, the power generation floating body proceeds at the sailing angle at which the power generation efficiency of the wind power generation increases in the sea area of the tidal current.

According to the power generation floating body described in Appendix 5, it is possible to realize the sea route plan generating system described in Appendix 1.

The present disclosure can be modified as appropriate within the scope and spirit of the disclosure that can be read from the claims and the entire specification, and a sea route plan generating system accompanied by such a modification is also included in the technical idea of the present disclosure.

What is claimed is:

1. A sea route plan generating system, comprising:
a sea route plan generating unit for generating, with respect to at least one power generation floating body that performs wind power generation using a kite while sailing at sea, a sea route plan for sailing the power generation floating body at a predetermined sailing angle based on wind conditions; and
a tidal current determining unit for determining whether a tidal current flowing in a direction opposite to a wind direction is present, based on the wind conditions, wherein
when determination is made that the tidal current is present, the sea route plan generating unit generates the sea route plan such that the power generation floating body proceeds at the sailing angle at which power generation efficiency of the wind power generation increases in a sea area of the tidal current.

2. The sea route plan generating system according to claim 1, wherein the sailing angle at which the power generation efficiency increases is a sailing angle at which an apparent wind that is received by the kite increases.

3. The sea route plan generating system according to claim 1, further comprising:
an information acquisition unit for acquiring information externally, wherein
the tidal current determining unit determines whether the tidal current is present, based on tidal current conditions information regarding the tidal current that is acquired by the information acquisition unit, and on wind conditions information regarding the wind conditions that are acquired by the information acquisition unit, and
the sea route plan generating unit generates the sea route plan based on the wind conditions information.

4. The sea route plan generating system according to claim 1, wherein
a plurality of the power generation floating bodies creates a fleet while communicating among the power generation floating bodies,
state information including at least one of a sailing state and a power generating state of each of the power generation floating bodies is shared among the power generation floating bodies,
the tidal current determining unit determines whether the tidal current is present, based on a change in state information of each of the power generation floating bodies, and
when determination is made that the tidal current is present, the sea route plan generating unit generates the sea route plan such that the sea area of the tidal current is included.

5. A power generation floating body that performs wind power generation using a kite while sailing at sea, the power generation floating body comprising:
a sea route plan generating unit for generating a sea route plan for sailing the power generation floating body at a predetermined sailing angle based on wind conditions; and
a tidal current determining unit for determining whether a tidal current flowing in a direction opposite to a wind direction is present, based on the wind conditions, wherein
when determination is made that the tidal current is present, the sea route plan generating unit generates the sea route plan such that the power generation floating body proceeds at the sailing angle at which power generation efficiency of the wind power generation increases in a sea area of the tidal current.
